(19) United States
(12) Patent Application Publication
(10) Pub. No.: US 2003/0096047 A1
(43) Pub. Date: May 22, 2003

(54) Low calorie beverages containing high intensity sweeteners and arabinogalactan

(76) Inventors: William E. Riha III, Somerset, NJ (US); Martin Jager, Gauersheim (DE)

Correspondence Address: Ferrells, PLLC, P.O. Box 312, Clifton, VA, 20124-1706, US

(21) Appl. No.: 10/245,129

(22) Filed: Sep. 17, 2002

Related U.S. Application Data
(63) Continuation of application No. 09/761,302, filed on Jan. 17, 2001, now abandoned.
(60) Provisional application No. 60/179,833, filed on Feb. 2, 2000.

(51) Int. Cl. A23L 1/236

(52) U.S. Cl. 426/548

(57) ABSTRACT

Low calorie beverages sweetened with high intensity sweeteners are provided with arabinogalactan in an amount effective to mask bitter aftertaste or other off-note sensory characteristics associated with the high intensity sweeteners. Particularly preferred embodiments include blends of high intensity sweeteners and ratios of arabinogalactan to each high intensity sweetener in the blend of at least about 40.

### CLAIM FOR PRIORITY

This non-provisional application claims the benefit of the filing date of U.S. Provisional Patent Application Serial No. 60/179,833, of the same title, filed Feb. 2, 2000.

### TECHNICAL FIELD

The present invention relates generally to low calorie beverages and more particularly to low calorie beverages sweetened with high intensity sweeteners containing arabinogalactan as a bitter aftertaste masking agent.

### BACKGROUND

Arabinogalactan is a known food additive. There is disclosed in an article entitled “Effective Stabilizing Agents and Aspartame on the Sensory Properties of Orange Sherbet”, Journal of Food Science, Vol. 43, (1978), various sherbet compositions which include both aspartame and arabinogalactan. One such composition is shown in Table 2, page 936 of the Food Science article to include about 10% arabinogalactan. On page 937-938 it is noted that when arabinogalactan was added to a level of 10% the arabinogalactan imparted undesirable properties to the composition including discoloration and undesirable odors.

In U.S. Pat. No. 4,228,198 to Burge et al. there is disclosed sweetening compositions containing at least one sweetener selected from a protein sweetener and saccharin, together with arabinogalactan. The ratio by weight of arabinogalactan to saccharin is generally not to exceed 1:1 when saccharin is used as the only sweetener. Compositions are reported to possess enhanced sweetening properties as compared with the composition containing no sweetness modifier. It is noted that the '198 patent does not teach or suggest the use of arabinogalactan with acesulfame K sweetening compositions.

U.S. Pat. No. 4,810,516 to Kong-Chan discloses reduced calorie chocolate confections in which a non-digestible polyol fatty acid polyester is substituted for natural fat and an artificial sweetener plus a partially or wholly non-digestible carbohydrate or bulking agent is substituted for sugar. Among the various components listed are: acesulfame K (sometimes referred to as “Ace-K” herein) as a sweetener, see Col. 2, line 62 and various bulking agents including lactitol, carboxymethylcellulose, and arabinogalactan. See Col. 3, lines 34-39. It is further noted in Example 2 that the ratio of lactitol (bulking agent) to aspartame (artificial sweetener) in example 2 is less than about 10:1.

There is disclosed in WIPO Publication No. WO 92/11084 encapsulated sweeteners such as aspartame provided with a protective shell material which enable the sweetener to resist temperature. Among the various ingredients which may be used to encapsulate the sweetener there is listed on page 9 arabinogalactan.

Of very general interest is WIPO Publication No. WO 98/04156 wherein there is disclosed a low calorie synergistic sweetening composition including intense sweeteners, bulk sweeteners and a small amount of simple sugar sweeteners to assist with the browning of baked food products. Also included are anti-flatulent agents used to help break up the gas created as the polysaccharides are metabolized by the intestinal microflora.

WIPO Publication No. WO 99/17618 (Wrigley) discloses chewing gums containing arabinogalactan and methods of making such gums. In one embodiment the gum comprises about 5 to about 95% gum base, about 0.1 to about 10% flavoring agent and arabinogalactan, the arabinogalactan being a bulking agent in the gum. The arabinogalactan provides the gum with unique properties and the gum is non-cariogenic. In other embodiments the arabinogalactan is co-dried with sweeteners or evaporated with a plasticizing syrup to produce unique sweetening ingredients and syrups for gum. The arabinogalactan may also be provided in the form of a rolling compound on the gum or used with sugars or polyols to form a hard coating for a coated pellet gum. High intensity sweeteners such as aspartame, alitame, acesulfame K, salts of acesulfame, cyclamate, and its salts, saccharin and its salts, sucralose, thaumatin, monellin, dihydrochalcone, stevioside, glycyrrhizin and combinations thereof are noted in the document. See page 7. Further noted in example 74, page 24, is that some of the arabinogalactan can be replaced by substituting aspartame and acesulfame K in a ratio of 1:1.

### SUMMARY OF INVENTION

There is provided in accordance with a first aspect of the present invention a low calorie beverage including water, a flavor component, optionally including an acidulant, with a high intensity sweetener or blend of high intensity sweeteners, and from about 0.25 weight percent to about 3 weight percent, arabinogalactan. Illustrative of the high intensity sweeteners are acesulfame potassium, aspartame, sucralose, saccharin, cyclamates, neohesperdine dihydrochalcone and mixtures thereof. Flavor components may be, for example, fruit flavors, tea flavors, cola flavors and the like. The beverages may be prepared from a syrup concentrate or a dry mix. In some embodiments from 100-500 ppm high intensity sweetener is typical. In specific embodiments the beverage includes from about 225 ppm to about 325 ppm of high intensity sweetener or blend of high intensity sweeteners. Typically, the beverage includes from about 0.5 weight percent to about 2 weight percent arabinogalactan. In some preferred embodiments, the beverage includes from about 0.75 weight percent to about 1.25 weight percent of arabinogalactan.

A variety of high intensity sweeteners may be used in accordance with the present invention. Particularly preferred sweeteners include acesulfame potassium, aspartame, and sucralose. Other high intensity sweeteners which may be employed include alitame, cyclamates, dihydrochalcone sweeteners, L-sugars, saccharin, stevioside, glycyrrhizin, apioglycyrrhizin, mogrosides, phyllodulcin, protein sweeteners such as thaumatin, monellin, mabinlins, pentadin, and highly sweet plant constituents such as hernandulcin, rubusoside, baiyunoside, steroidal saponins, and the like.

Particularly preferred embodiments include beverages with a blend of acesulfame potassium and aspartame as well as beverages that contain blends of acesulfame potassium and sucralose.

The ratio of arabinogalactan to each high intensity sweetener in the beverage is typically at least about 40 and the amount of high intensity sweetener in the beverage is typically less than about 350 ppm. Various flavors and compositions may be employed. Particularly preferred beverages include tea beverages such as iced tea, and carbonated beverages such as cola, lemon-lime, and other flavored carbonated beverages. Any acidulant may be employed while particularly preferred acidulents include citric acid, phosphoric acid and malic acid. If so desired, additional fiber may be added such as maltodextrin, inulin, oligofructose and mixtures thereof.

In another aspect of the invention there is provided a low calorie beverage including water, a flavor component optionally including an acidulant with from about 200 to about 350 ppm of a blend of high intensity sweeteners and from about 0.5 weight percent to about 2 weight percent of arabinogalactan, wherein the ratio of arabinogalactan to each high intensity sweetener present in the beverage is at least about 30. Particularly preferred blends of high intensity sweetener are acesulfame potassium and aspartame in a weight ratio of acesulfame potassium to aspartame of from about 1:5 to about 1:1.

Other preferred beverages include beverages which are sweetened with a blend of acesulfame potassium and sucralose in a weight ratio of acesulfame potassium to sucralose of from about 1:1 to about 5:1.

In yet another aspect of the present invention, a beverage includes water, a flavor component, optionally an acidulant, a tri-blend of high intensity sweeteners and from about 0.25 to about 3 weight percent arabinogalactan. From about 0.5 to about 2 weight percent arabinogalactan is preferred, while a particularly preferred tri-blend includes acesulfame potassium, aspartame and a cyclamate sweetener.

In still yet another aspect of the present invention there is provided a low calorie beverage comprising of water, a flavorant, optionally including an acidulant, acesulfame potassium, and arabinogalactan in an amount effective to mask bitter after taste associated with acesulfame potassium. Typically, acesulfame potassium is present in an amount of from about 100 to about 300 ppm by weight. Arabinogalactan is typically present in an amount from about 0.5 to about 2 percent by weight. Particularly preferred embodiments may include from about 0.75 to about 1.25 weight percent arabinogalactan. As noted above, typical beverages may include colas, tea beverages, fruit flavored beverages including lemon flavored beverages, such as lemon-lime carbonated beverages.

Beverages in accordance with the present invention have advantageous qualities beyond the flavor-enhancing cooperation between the arabinogalactan and the high intensity sweetener. For one, arabinogalactan acts as an immunostimulant to activate the immune system. Moreover, as soluble fiber, the arabinogalactan present in the beverage is operative to promote intestinal health as is appreciated in the food science art.

### DETAILED DESCRIPTION

The beverages in accordance with the invention include a flavor enhancing amount of arabinogalactan. Arabinogalactan is known to be useful as a food additive as noted above. Food grades of arabinogalactan are available from Larex Co. of St. Paul, Minn., under the trade name FIBERAID. The patent literature likewise describes various methods of preparing arabinogalactan from the wood of the Western larch tree.

In U.S. Pat. No. 4,950,751 to DeWitt there is disclosed an improved method for the extraction of galactans, and especially arabinogalactan, which involves application of sonic energy to a mixture of galactan containing starting material and extraction medium. Preferably, the method involves providing a mixture of Western larch chips and water, and subjecting this mixture to an acoustic or ultrasonic field for enhancing galactan recovery. It is noted in the '751 patent that arabinogalactan is a polysaccharide made up of galactose and arabinose units in the ratio of approximately five or six to one. Arabinogalactan is found in abundance, for example, in the wood of the Western larch tree (Larix occidentalis). While arabinogalactan is present throughout the tree, the lower portion of the trunk, referred to as the “butt cut” contains so much arabinogalactan, of the order of 15 to 25% and more of the weight of the dry log, that the butt cut is neither good for lumber nor for pulping purposes. For years, this portion of the tree has been discarded and left in the forest. If the Western larch is used as the starting material, the wood should be subdivided into chips, preferably having an average length of from about ¾ to about 1¼ inches and an average width of from about ¼ to 1 inch. The extraction medium is preferably aqueous, but may include acid or alkali or organic solvents such as dimethylsulfoxide (DMSO) and is used at a level such that the ratio of particles to extraction medium varies from about 1:3 to 1:8, more preferably from about 1:4 to 1:6. The '751 patent is incorporated herein by reference in its entirety.

U.S. Pat. No. 5,116,969 to Adams et al. discloses an ultrarefined arabinogalactan product. The subject arabinogalactans fall within the molecular weight range of 6,000-2,500,000 and have tannic acid equivalents of less than about 0.5 mg/g. The preferred product has a molecular weight within the range of 6,000 to 1,300,000 and tannic acid equivalent of higher than about 0.25. The product is nearly colorless and is tasteless and odorless. It is prepared first by making a crude water extract of a natural source such as larch wood. This extract is next refined by adding an active MgO to precipitate the bulk of the lignans and iron containing compounds. Following that, it is processed through a membrane no larger than about 0.45 microns to remove any species having molecular weights in excess of about 2,500,000. The permeate may then be treated on successfully smaller membranes down to about 6,000 daltons. The permeate through the 6,000 dalton membranes contains virtually all of the monomers, homopolymers, and other materials that would contribute to the osmolality of a resulting solution of the ultrarefined arabinogalactan. Partially refined arabinogalactan gums have been available commercially for a number of years. This polysaccharide occurs widely in many plant and bacteria species. It is found in significant quantities in the trees of the genus Latrix, particularly in the lower portion of the Larix occidentalis Nuttall (Western larch). The characterization, production, and uses of larch arabinogalactan gums is discussed by M. F. Adams and B. V. Ettling in Industrial Gums, 2^{nd} Ed. R. L. Whistler and J. N. BeMiller Eds., pp 415-427, Academic Press, New York, (1973). In some old growth trees the arabinogalactan is present in the butt log in such great quantities as causing ring shake (circular splits) and render the log much less valuable for lumber manufacture. This same wood, when comminuted, provides a ready source of arabinogalactan when extracted with warm water. Extraction is normally carried out in a countercurrent manner with water at a temperature below about 70° C. It is noted in the '969 patent that arabinogalactan is a polymer of arabinose and galactose in varying ratios which are combined to form molecules with a general ball-like configuration. There is a range of molecular sizes varying from monomolecular and low molecular weight homopolymers to macromolecules with molecular weights well over 2,500,000. Molecular weight distribution tends to be bimodal with peaks at about 50,000 and 90,000. The '969 patent is hereby incorporated by reference in its entirety.

In the beverage formulations hereinafter described, any suitable source of arabinogalactan may be employed, provided the product has the described organoleptic characteristics. Unless otherwise indicated, percentages appearing in this application refer to weight percent and likewise ppm refers to parts per million by weight unless the context indicates otherwise.

Arabinogalactan was added at a concentration of 1% to the solutions in water shown in Table 1. The solutions were tested by a trained panel versus a control that did not contain arabinogalactan. The method was a paired comparison by descriptive analysis. This evaluation technique is described in Sensory Evaluation Techniques, 2^{nd} Ed., Meilgaard, M. et al. on page 198 and following. Certain applications of descriptive analysis require evaluation of a few detailed attributes without a full analysis of all the parameters of flavor, texture, and/or appearance. Use of the Modified Spectrum™ Descriptive technique in a quality control setting is described by for two applications, a Comprehensive Descriptive procedure and a Difference-from-Control procedure. In the comprehensive Descriptive procedure, a reduced set of characteristics is selected by testing the production variability for most characteristics among consumers and then choosing those characteristics whose variability most affects consumer acceptance. These relationships are used to set sensory specifications that allow the QC sensory program to monitor production. The intensities of key sensory attributes are measured to determine whether samples fall in or out of specification, and for what attributes. Such a technique permits detection and definition of any problem areas which can then be related to processing or raw material sources. The Comprehensive Descriptive procedure may also be applied to the sensory properties of incoming raw materials and/or to in-process batches.

In a second application, more pertinent to the results below, the Modified Spectrum™ Descriptive is coupled with a Difference-from-Control test. The modified descriptive panel is trained to recognize the control or standard product along with other samples which the fully trained panel has described as different from the control on the key attributes. The panel is shown the full range of samples and asked to rate them using the normal Difference-from-Control scale (see Chapter 6.1, p. 81). The panel understand that occasionally one of the test samples during normal testing of production will be a blind control and/or one of the original “small difference” or “large difference” demonstration samples. This precaution reduces the likelihood of panelists anticipating too much change.

The Difference-from-Control test provides an indication of the magnitude of the difference from a standard product.

TABLE 1
Water Solutions

| | |
|---|---|
| Example 1 | 300 ppm Ace-K/1% arabinogalactan |
| Example 2 | 135 ppm Ace-K/135 ppm APM/1% arabinogalactan |
| Example 3 | 225 ppm Ace-K/75 ppm TGS (sucralose)/1% |
| | arabinogalactan |
| Example 4 | 330 ppm saccharin/1% arabinogalactan |
| Example 5 | 100 ppm saccharin/150 ppm APM (aspartame)/1% |
| | arabinogalactan |

Results:

The Example solutions 1-5 were evaluated for sweetness attributes against a control solution without arabinogalactan specifically for chemical or bitter aftertaste. Both the control solution and the control plus 1% arabinogalactan were tasted in a similar manner and compared for taste qualities. In Table 2 is a summary of the results.

TABLE 2
Aftertaste Results

| Example | Solution | Comments |
|---|---|---|
| Control Example A | 300 ppm Ace-K | — |
| Example 1 | 300 ppm Ace-K/1% | — |
| | arabinogalactan | |
| Control Example B | 135 ppm Ace-K/135 ppm | — |
| | aspartame | |
| Example 2 | 135 ppm Ace-K/135 ppm | Bitter after taste reduced, |
| | aspartame/1% | improved sweetness pro- |
| | arabinogalactan | file as compared with |
| | | control Example B |
| Control Example C | 225 ppm Ace-K/75 ppm | — |
| | Sucralose | |
| Example 3 | 225 ppm Ace-K/75 ppm | Reduction in chemical |
| | Sucralose/1% | and bitter after taste; |
| | arabinogalactan | improved sweetness pro- |
| | | file as compared to |
| | | control Example C |
| Control Example D | 330 ppm Saccharin | — |
| Example 4 | 330 ppm Saccharin/1% | No improvement |
| | arabinogalactan | |
| Control Example E | 100 ppm Saccharin/ | — |
| | 150 ppm aspartame | |
| Example 5 | 100 ppm Saccharin/ | Reduction of bitter after |
| | 150 ppm aspartame/1% | taste as compared to |
| | arabinogalactan | control Example E |

### EXAMPLE 6

In a carbonated cola beverage, arabinogalactan was added at 1% to a cola beverage sweetened with 300 ppm acesulfame potassium. The bitter or chemical aftertaste of the beverage was reduced compared to a control beverage with no arabinogalactan.

### EXAMPLE 7

A carbonated lemon-lime beverage may be formulated from a suitable syrup prepared in accordance with the present invention having the respective approximate syrup and beverage compositions shown in Table 3. Typically, a beverage is made from the concentrate with one part concentrate to five parts water.

TABLE 3
Lemon Lime Beverage

| | Syrup composition | Beverages composition |
|---|---|---|
| Ingredient | % w/w | % w/w |
| Water (carbonated) | 93 | 98 |
| Arabinogalactan | 6 | 1 |
| Sunett ® Brand Ace-K | 0.1 | 0.018 |
| Aspartame | 0.1 | 0.018 |
| Lemon Lime Flavor | 0.1 | 0.017 |
| Potassium Sorbate | 0.1 | 0.017 |
| Caffeine | 0.080 | 0.013 |
| Phosphoric Acid, 75% | 0.030 | 0.005 |
| Citric Acid | 0.025 | 0.004 |

### EXAMPLES 8-17

The present invention may be used, for example, to make acidified beverages such as fruit beverages, tea, or lemon and cranberry beverages. The acidulent or acid component may be of any suitable acid such as phosphoric acid (however malic and citric acid are preferred in some cases). An alkali metal salt of an organic acid may be added if so desired, preferably in an amount from about 0.1 to about 0.3 percent by weight. The amount of sweetener used in beverages will vary slightly from flavor to flavor. The total amount of sweeteners related to the required sweetness of the final product. The preferred sweetness of each beverage flavor is a function of the beverage industry and consumer demand. It is generally recognized that products similar to the lemon and mango juice beverages tend to be preferred with sweetener levels of about 400 to about 500 parts per million by weight of sweetener. Some other beverages have preferred ranges as follows:

TABLE 4
Concentration for Various Flavors

| | Preferred Sweetener Mixture |
|---|---|
| Flavor | Concentration ppm |
| Tea | 250-350 |
| Strawberry | 300-400 |
| Cranberry | 350-450 |

Various flavor components useful for beverages which may be made in accordance with the invention appear in Table 5.

TABLE 5
Ingredients

| | |
|---|---|
| Flavor Components | Supplier |

Flavors

| | |
|---|---|
| Mango Melon 341340 | Givaudan Roure, Cincinnati, OH |
| Kiwi Strawberry 133739 | Givaudan Roure, Cincinnati, OH |
| Lemon 9/79K404 | Dragoco, Totowa, NJ |
| Natural Lemon Oil 3202 | Ottens Flavor, Philadelphia, PA |
| Cranberry Raspberry 4813173/BM | Bell Flavors, Northbrook, IL |
| Tea Extract 8030 | Fidco, Solon, OH |
| Juice Concentrates | |
| Mango Puree 15/17 Brix | Gillette, Union, NJ |
| Mango 65 Brix | Gillette, Union, NJ |
| Strawberry 65 Brix | Kerr, Salem, OR |
| Lemon 400 GPL | Gillette, Union, NJ |
| Cranberry s50 Brix | Kerr Salem, OR |
| Additional Components | |
| Acesulfame Potassium | Nutrinova, Inc., Somerset, NJ |
| Aspartame (APM) | Nutrasweet, St. Louis, MO |
| Citric Acid | ADM, Decatur, IL |
| Malic Acid | Bartek Ingredients Inc., Ontario, |
| | Canada |
| Sodium Citrate | ADM, Decatur, IL |

### EXAMPLE 8

### Mango Beverage

Mango beverage may be prepared as in Table 6. The beverage prepared by mixing the juice concentrate flavors, and acid along with other ingredients shown in Table 6 with a suitable amount of water. This mixture is then heated to 180° F. The sweeteners are added and then the beverage is sealed and cooled. The heat processing step is performed to mimic a standard hot filling process which is common in juice and tea beverages. The sweeteners are added after hot fill to eliminate possible breakdown of aspartame during the heating process. The juice content of this beverage is 10%. Juice content is based on a regulatory definition of single strength juices. If so desired, the beverages may also be prepared as a dry mix and then dissolved in water as will be readily appreciated by those of skill in the art.

TABLE 6
Mango Beverage Formulations

| Ingredient | % |
|---|---|
| Mango Concentrate | 0.60 |
| Mango Puree | 1.00 |
| Mango Melon Flavor | 0.28 |
| Citric Acid | 0.0-0.28 |
| Aspartame | 0.016-0.05 |
| Acesulfame Potassium | 0.0-0.016 |
| Arabinogalactan | 1% |
| Water | Balance to 100% |

### EXAMPLE 9

### Lemonade (10% Juice)

Lemonade is prepared in a similar manner to the mango melon beverage detailed above. Flavors, concentrate(s), acid, buffer, and water are mixed and heated, sweeteners are added along with arabinogalactan and the beverage is bottled. The main difference from the previous formulation is the use of a buffer (sodium citrate). The lemon juice concentrate has a very low pH which, unless adjusted for, may result in a finished lemonade pH that is too low to fit into the design range. Therefore the buffer (sodium citrate) was added to raise the pH. The formulation is outlined in the following table.

TABLE 7
Lemonade Formulations

| Ingredient | % |
|---|---|
| Lemon Juice Concentrate | 0.84 |
| Flavor | 0.08 |
| Lemon Oil | 0.04 |
| Citric Acid | 0.0-0.08 |
| Sodium Citrate | 0.0-.25 |
| Aspartame | 0.016-0.05 |
| Acesulfame Potassium | 0.0-0.016 |
| Arabinogalactan | 1% |
| Water | Balance to 100% |

### EXAMPLE 10

### Cranberry Raspberry Juice

Cranberry raspberry juice is formulated in the same manner as previously defined. This juice however, contains both malic and citric acid as the acidulant. The formulation is outlined below.

TABLE 8
Cranberry Beverage Formulations

| Ingredient | % |
|---|---|
| Apple Juice Concentrate | 1.64 |
| Raspberry Juice Concentrate | 1.06 |
| Cranberry Juice Concentrate | 0.87 |
| Flavor | 0.10 |
| Malic Acid | 0.0-26 |
| Citric Acid | 0.0-0.26 |
| Sodium Citrate | 0.0-.25 |
| Aspartame | 0.016-0.05 |
| Acesulfame Potassium | 0.0-0.016 |
| Arabinogalactan | 1% |
| Water | Balance to 100% |

### EXAMPLE 11

### Strawberry Kiwi (5% Juice)

Strawberry Kiwi juice beverage is prepared in a similar manner to the previous examples. The formulation for this beverage is detailed in the following table. This beverage includes pectin, which is used to provide viscosity and mouth feel. The pectin is solubilized prior to mixing of other ingredients. Additionally, malic acid is used as the acidulant. Malic acid is often used in juice beverages. The process then follows that previously defined.

TABLE 9
Strawberry Beverage Formulations

| Ingredient | % |
|---|---|
| Strawberry Juice Concentrate | 0.25 |
| Kiwi Juice Concentrate | 0.47 |
| Apple Juice Concentrate | 0.16 |
| Pectin | 0.15 |
| Flavor | 0.10 |
| Malic Acid | 0.0-0.37 |
| Aspartame | 0.0165-0.045 |
| Acesulfame Potassium | 0.0-0.0165 |
| Arabinogalactan | 1% |
| Water | Balance to 100% |

### EXAMPLE 12

### Iced Tea

The Iced Tea is prepared by blending dry ingredients (maltodextrin, tea powder, tea essence, malic acid, and flavor) with water. The mixture is heated to 180° F., sweeteners were added and the mixture is bottled. The formulation is outlined in the following table.

TABLE 10
Iced Tea Formulations

| Ingredient | % |
|---|---|
| Maltodextrin | 2.34 |
| Tea Powder | 0.21 |
| Tea Essence | 0.032 |
| Flavor | 0.008 |
| Malic Acid | 0.24-0.32 |
| Aspartame | 0.015-0.045 |
| Acesulfame Potassium | 0.0-0.015 |
| Arabinogalactan | 1% |
| Water | Balance to 100% |

Beverages are formulated as above with different levels of high intensity sweeteners (aspartame, acesulfame potassium) acid (malic, citric) and buffer (sodium citrate).

### EXAMPLES 13-17

Cola beverages are prepared from available ingredients by way of a standard procedure. A cola flavor may be either natural or artificial. Such cola flavors arc commercially available, for example, from International Flavor and Fragrances, Dayton, N.J.; Artificial # 13573011 and Natural #K3559549. Commercial cola flavors are also available from Tastemaker, Cincinnati, Ohio and Givaudan Roure, Clifton, N.J. The terminology “acid” or “acidulant” refers to an ingredient that contributes sourness to the beverage and is added to balance the flavor profile by reducing chemical or sweetener side tastes. Acids may include malic acid, citric acid, phosphoric acid, or combinations thereof.

Optimum cola beverages have suitable cola flavor, balanced sweetness and sour levels and low chemical side tastes. The beverage includes a cola flavor, a high intensity sweetener, typically a blend of acesulfame potassium and an acidulant. The cola flavor intensity varies with the sweetener blend ratio and the acid levels.

Cola flavored carbonated beverages may be formulated by varying the aspartame and acesulfame potassium levels (90/10-50/50 sweetness contribution) and varying acid level (0.05-0.005% in the finished beverage). See Table 11.

Concentrate preparation is the first phase of beverage development. The concentrate is prepared by mixing phosphoric acid (75% Rhone-Poulenc), citric acid (anhydrous, ADM, Decatur, Ill.), caffeine (Mallinckrodt, Paris, Ky.), Caramel Color (DS400, Sethness, Chicago, Ill.), Cola Flavor (SN018976, International Flavors and Fragrances, Dayton, N.J.), sweeteners (Acesulfame potassium—Sunett® Brand sweetener—Nutrinova, Inc., Somerset, N.J.; aspartame—Holland Sweetener, Atlanta, Ga.) and water (distilled—American Eagle, Harwick, N.J.). The concentrate is blended until all ingredients are dissolved using a magnetic stirring plate. Fifty milliliters of the concentrate is added to 250 ml of carbonated water which completes preparation of the cola beverage. arabinogalactan is added to the ingredients listed in Table 11 to having the concentration to about 1% or so in the finished beverage.

TABLE 11
Concentrate formulation for carbonated cola beverage

| | | | | | |
|---|---|---|---|---|---|
| Ingredient | 50/50 | 90/10 | 50/50 | 90/10 | 70/30 |
| Aspartame (g) | 0.495 | 1.338 | 0.495 | 1.338 | 0.810 |
| Acesulfame | 0.495 | 0.147 | 0.495 | 0.147 | 0.345 |
| Potassium (g) | | | | | |
| Phosphoric Acid | 2.000 | 2.000 | 1.500 | 1.500 | 0.700 |
| (75%) (ml) | | | | | |
| Citric Acid (g) | 0.125 | 0.125 | 0.125 | 0.125 | 0.125 |
| Caffeine (g) | 0.400 | 0.400 | 0.400 | 0.400 | 0.400 |
| Caramel Color (g) | 2.200 | 2.200 | 2.200 | 2.200 | 2.200 |
| Cola Flavor (ml) | 1.950 | 1.950 | 1.950 | 1.950 | 1.950 |
| Water (ml) | 493.325 | 491.840 | 492.835 | 492.340 | 493.470 |
| Arabinogalactan (%) | Typically 6% | Typically 6% | Typically 6% | Typically 6% | Typically 6% |

While the invention has been described in detail, various modifications within the spirit and scope of the present invention, which is set forth in the appended claims, will be readily apparent to those of skill in the art.

What is claimed is:

1. A low calorie beverage comprising water, a flavor component, optionally including an acidulant, with a high intensity sweetener or blend of high intensity sweeteners, and from about 0.25 weight percent to about 3 weight percent arabinogalactan.

2. The beverage according to claim 1, wherein said beverage includes a sweetener selected from the group consisting of acesulfame potassium, aspartame, sucralose, saccharin, cyclamates, neohesperdine dihydrochalcone and mixtures thereof.

3. The beverage according to claim 1, wherein said beverage contains a flavor component selected from the group consisting of fruit flavors, tea flavors and cola flavors.

4. The beverage according to claim 1, wherein said beverage is prepared from a dry mix.

5. The beverage according to claim 1, wherein said high intensity sweetener or blend of high intensity sweeteners is present in an amount of from about 100 to about 500 ppm.

6. The beverage according to claim 5, wherein said beverage comprises form about 225 ppm to about 325 ppm of a high intensity sweetener or blend of high intensity sweeteners.

7. The beverage according to claim 6, wherein said beverage comprises from about 0.5 weight percent to about 2 weight percent arabinogalactan.

8. The beverage according to claim 7, wherein said beverage comprises from about 0.75 weight percent to about 1.25 weight percent arabinogalactan.

9. The beverage according to claim 1, wherein said beverage comprises from about 0.5 percent to about 2 weight percent arabinogalactan.

10. The beverage according to claim 1, wherein said high intensity sweetener is acesulfame potassium.

11. The beverage according to claim 1, wherein said high intensity sweetener is aspartame.

12. The beverage according to claim 1, wherein said high intensity sweetener is sucralose.

13. The beverage according to claim 1, wherein said beverage contains a blend of acesulfame potassium and aspartame.

14. The beverage according to claim 1, wherein said beverage contains a blend of acesulfame potassium and sucralose.

15. The beverage according to claim 1, wherein the ratio or arabinogalactan to each high intensity sweetener in the beverage is at least about 40.

16. The beverage according to claim 11, wherein the amount of high intensity sweetener in the beverage is less than about 350 ppm.

17. The beverage according to claim 1, wherein said beverage is a tea beverage.

18. The beverage according to claim 1, wherein said beverage is a carbonated beverage.

19. The beverage according to claim 18, wherein said beverage is a cola beverage.

20. The beverage according to claim 18, wherein said beverage is a lemon-lime beverage.

21. The beverage according to claim 1, wherein said beverage contains an acidulant selected from the group consisting of citric acid, malic acid and phosphoric acid.

22. The beverage according to claim 1, further including a fiber selected from the group consisting of maltodextrin, inulin and oligofructose.

23. A low calorie beverage comprising water, a flavor component, optionally including an acidulant, with from about 200 to about 350 ppm of a blend of high intensity sweeteners and from about 0.5 percent to about 2 weight percent of arabinogalactan, wherein the ratio of arabinogalactan to each high intensity sweetener present is at least about 30.

24. The beverage according to claim 23, wherein said blend of high intensity sweeteners is a blend of acesulfame potassium and aspartame.

25. The beverage according to claim 24, wherein the weight ratio of acesulfame potassium to aspartame is from about 1:5 to about 1:1

26. The beverage according to claim 23, wherein said blend of high intensity sweeteners is a blend of acesulfame potassium and sucralose.

27. The beverage according to claim 26, wherein the weight ratio of acesulfame potassium to sucralose is from about 1:1 to about 5:1.

28. A low calorie beverage comprising water, a flavor component, optionally including an acidulant, a tri-blend of high intensity sweeteners and from about 0.25 to about 3 weight percent arabinogalactan.

29. The beverage according to claim 28, wherein said beverage contains from about 0.5 to about 2 weight percent arabinogalactan.

30. The beverage according to claim 29, wherein said tri-blend of high intensity sweeteners comprises acesulfame potassium, aspartame and a cyclamate sweetener.

31. A low calorie beverage comprising water, a flavorant, optionally including an acidulant, acesulfame potassium, and arabinogalactan in an amount effective to mask bitter aftertaste associated with acesulfame potassium.

32. The low calorie beverage according to claim 31, wherein acesulfame potassium is present in an amount of from about 100 to about 300 ppm by weight.

33. The low calorie beverage according to claim 32, wherein said beverage contains arabinogalactan in an amount of from about 0.5 to about 2 percent by weight.

34. The low calorie beverage according to claim 33 wherein said beverage contains arabinogalactan in an amount of from about 0.75 to about 1.25 weight percent.

35. The beverage according to claim 33, wherein said beverage is a cola beverage.

36. The beverage according to claim 33, wherein said beverage is a tea beverage.

37. The beverage according to claim 33, wherein said beverage comprises a lemon flavor.

38. The beverage according to claim 33, wherein said beverage is a lemon-lime beverage.
